(19) United States
(12) Patent Application Publication
(10) Pub. No.: US 2024/0194392 A1
(43) Pub. Date: Jun. 13, 2024

(54) COIL COMPONENT

(71) Applicant: TDK CORPORATION, Tokyo (JP)

(72) Inventors: Masataro SAITO, Tokyo (JP); Hitoshi OHKUBO, Tokyo (JP); Masazumi ARATA, Tokyo (JP); Hokuto EDA, Tokyo (JP); Kohei TAKAHASHI, Tokyo (JP); Takamasa IWASAKI, Tokyo (JP); Ryo FUKUOKA, Tokyo (JP)

(73) Assignee: TDK CORPORATION, Tokyo (JP)

(21) Appl. No.: 18/528,876

(22) Filed: Dec. 5, 2023

(30) Foreign Application Priority Data
Dec. 7, 2022 (JP) 2022-195709

(51) Int. Cl. H01F 27/28

(52) U.S. Cl. CPC H01F 27/2804; H01F 2027/2809

(57) ABSTRACT

In the coil component, the thickness of the first coil portion and the thickness of the second coil portion are different from each other in the thickness direction of the substrate, thereby achieving improvement in characteristics such as self-resonance frequencies and heat dissipation.

### CROSS-REFERENCE TO RELATED APPLICATIONS

This application is based upon and claims the benefit of priority from Japanese Patent Application No. 2022-195709, filed on 7 December, 2022, the entire content of which is incorporated herein by reference.

### TECHNICAL FIELD

The present disclosure relates to a coil component.

### BACKGROUND

Japanese Patent Application Publication No. 2017-34227 discloses a coil component in which a coil conductor including a pair of winding portions formed in a planar spiral shape on both surfaces of a substrate is provided inside an element body.

### SUMMARY

The inventors have studied the above-described configuration (that is, a configuration in which a coil conductor including a pair of winding portions formed in a planar spiral shape on both surfaces of a substrate is provided inside an element body). As a result, the inventors have newly found a technique improving a characteristic of the coil.

According to the present disclosure, there is provided a coil component in which a characteristic of a coil is improved.

A coil component according to one aspect of the present disclosure includes an element body, a substrate disposed inside the element body, a coil conductor including a first winding portion provided in a planar spiral shape on one surface of the substrate, a second winding portion provided in a planar spiral shape on the other surface of the substrate, and a penetration portion penetrating the substrate and connecting end portions of the first winding portion and the second winding portion to each other, and a pair of terminal electrodes provided on a surface of the element body and connected to the first winding portion and the second winding portion of the coil conductor, respectively, wherein when a thickness of the first winding portion in a thickness direction of the substrate is a first thickness and a thickness of the second winding portion is defined as a second thickness, the first thickness and the second thickness are different from each other.

In the coil component according to another aspect, in the thickness direction of the substrate, the substrate extends at a height position shifted from an intermediate height position of the element body.

In the coil component according to another aspect, in the thickness direction of the substrate, the substrate extends at an intermediate height position of the element body.

In the coil component according to another aspect, the element body has a pair of end surfaces orthogonal to the substrate and facing each other and a mounting surface orthogonal to the thickness direction of the substrate on the other surface side of the substrate, and the pair of terminal electrodes is provided on each of the pair of end surfaces.

In the coil component according to another aspect, each of the terminal electrodes has an L shape, the each of the terminal electrodes continuously covering the end surface and the mounting surface.

In the coil component according to another aspect, the second thickness is smaller than the first thickness.

In the coil component according to another aspect, the element body is made of a material containing metal powder and resin.

### BRIEF DESCRIPTION OF THE DRAWINGS

FIG. 1 is a schematic perspective view showing a coil component according to one embodiment.

FIG. 2 is an exploded perspective view of the coil component shown in FIG. 1.

FIG. 3 is an exploded perspective view showing the configuration of the substrate and the coil conductor.

FIG. 4 is a cross-sectional view taken along line IV-IV of the coil component shown in FIG. 1.

FIG. 5 is a side view showing the configuration of the substrate and the coil conductor.

FIGS. 6A to 6C are views showing steps in manufacturing the coil component.

FIG. 7 is a side view showing a configuration of the substrate and the coil conductor of the coil component according to a comparative example.

FIG. 8 is a graph showing experimental results.

FIG. 9 is a side view showing the configuration of the substrate and the coil conductor in a different mode.

### DETAILED DESCRIPTION

Hereinafter, embodiments for carrying out the present disclosure will be described with reference to the accompanying drawings. In the description of the drawings, the same or equivalent elements are denoted by the same reference numerals, and redundant description is omitted.

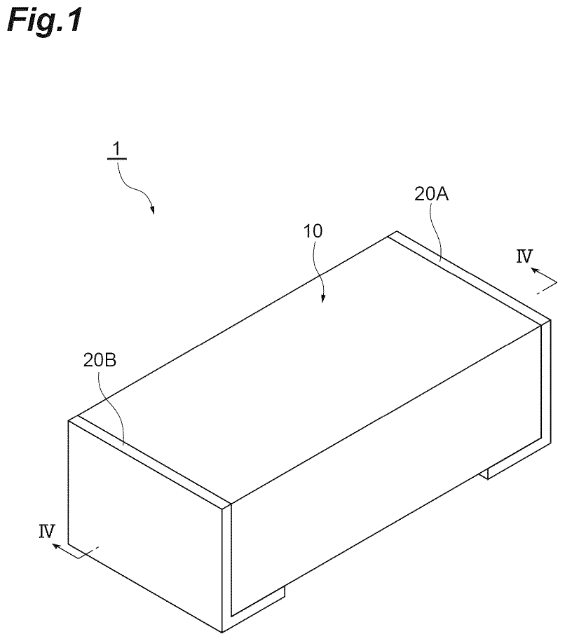

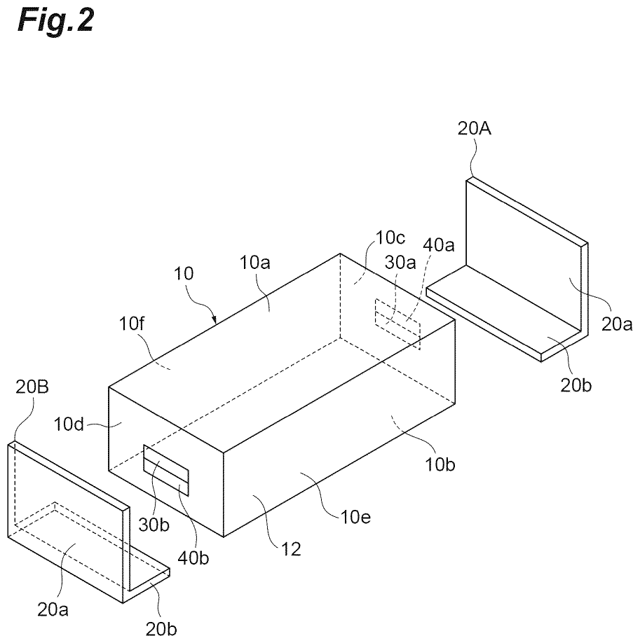

A coil component 1 according to one embodiment will be described with reference to FIGS. 1 to 4. As shown in FIGS. 1 and 2, the coil component 1 includes an element body 10 and a pair of external terminal electrodes 20A and 20B (terminal electrodes) provided on a surface of the element body 10.

The element body 10 has an outer shape of a substantially rectangular parallelepiped shape and includes a pair of main surfaces 10a and 10b facing each other, a pair of end surfaces 10c and 10d facing each other, and a pair of side surfaces 10e and 10f facing each other. The pair of end surfaces 10c and 10d and the pair of side surfaces 10e and 10f connect the pair of main surfaces 10a and 10b. In the present embodiment, the facing direction of the pair of main surfaces 10a and 10b is the height direction of the element body 10, the facing direction of the pair of end surfaces 10c and 10d is the long-side direction of the element body 10, and the facing direction of the pair of side surfaces 10e and 10f is the short-side direction of the element body 10. In the present embodiment, the main surface 10b serves as a mounting surface facing a base material on which the coil component 1 is mounted. As an example, the coil component 1 is designed to have dimensions of long side 2.0 mm, short side 1.25 mm, and height 1.0 mm.

Of the pair of external terminal electrodes 20A and 20B, the first external terminal electrode 20A is provided on the end surface 10c side of the element body 10. The first external terminal electrode 20A includes a portion 20a covering the end surface 10c and a portion 20b covering a part of the main surface 10b on the end surface 10c side, and has an L-shape continuously covering the end surface 10c and the main surface 10b. Of the pair of external terminal electrodes 20A and 20B, the second external terminal electrode 20B is provided on the end surface 10d side of the element body 10. Like the first external terminal electrode 20A, the second external terminal electrode 20B includes a portion 20a covering the end surface 10d and a portion 20b covering a portion of the main surface 10b on the end surface 10d side, and has an L-shape continuously covering the end surface 10d and the main surface 10b. In the present embodiment, the portions 20a covering the respective end surfaces 10c and 10d of the pair of external terminal electrodes 20A and 20B extend to height positions reaching the upper ends of the end surfaces 10c and 10d.

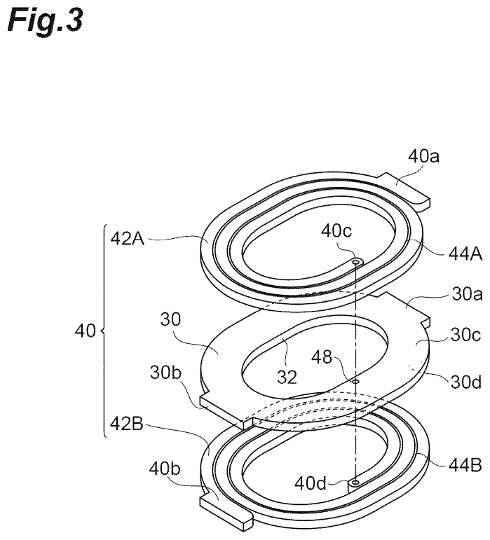

The element body 10 has a configuration in which a substrate 30 and a coil conductor 40 shown in FIG. 3 are provided inside a magnetic body 12.

The substrate 30 is disposed inside the element body 10. The substrate 30 extends between the pair of end surfaces 10c and 10d of the element body 10. The substrate 30 has end portions 30a and 30b exposed from the end surfaces 10c and 10c. The substrate 30 has a flat plate shape extending parallel to the main surfaces 10a and 10b of the element body 10, and has an upper surface 30c located on the main surface 10a side and a lower surface 30d located on the main surface 10b side. The substrate 30 has a substantially elliptical annular shape when viewed from the thickness direction of the substrate 30. An elliptical through hole 32 is provided in a central portion of the substrate 30.

The substrate 30 is made of a nonmagnetic insulating material. As the substrate 30, a substrate obtained by impregnating a glass cloth with an epoxy-based resin and having a thickness of 10 μm to 60 μm may be used. In addition to the epoxy resin, BT resin, polyimide, aramid, or the like may be used. Ceramic or glass may also be used as the material of the substrate 30. The material of the substrate 30 may be mass-produced printed circuit board materials, or resin materials used for BT printed circuit boards, FR4 printed circuit boards, or FR5 printed circuit boards.

The coil conductor 40 has a first coil portion 42A in which a first conductor pattern 43A for a planar air-core coil provided on the upper surface 30c of the substrate 30 is insulation-coated, a second coil portion 42B in which a second conductor pattern 43B for a planar air-core coil provided on the lower surface 30d of the substrate 30 is insulation-coated, and a through-hole conductor 48 connecting the first and second conductor patterns 43A and 43B.

The first conductor pattern 43A (first winding portion) is a planar spiral pattern serving as a planar air-core coil, and is formed by plating with a conductor material such as Cu. The first conductor pattern 43A is formed so as to be wound around the through hole 32 of the substrate 30. More specifically, as shown in FIG. 3, the first conductor pattern 43A is wound clockwise by three turns outward when viewed from above (in the Z direction).

An outer end portion 40a of the first conductor pattern 43A is exposed at the end surface 10c of the element body 10 and is connected to the external terminal electrode 20A covering the end surface 10c. An inner end portion 40c of the first conductor pattern 43A is connected to the through-hole conductor 48.

The second conductor pattern 43B (second winding portion) is also a planar spiral pattern serving as a planar air-core coil similarly to the first conductor pattern 43A, and is formed by plating with a conductor material such as Cu. The second conductor pattern 43B is also formed so as to be wound around the through hole 32 of the substrate 30. More specifically, the second conductor pattern 43B is wound counterclockwise by three turns outward when viewed from above (in the Z direction). That is, the second conductor pattern 43B is wound in a direction opposite to the first conductor pattern 43A when viewed from above.

An outer end portion 40b of the second conductor pattern 43B is exposed at the end surface 10d of the element body 10 and is connected to the external terminal electrode 20B covering the end surface 10d. An inner end portion 40d of the second conductor pattern 43B is aligned with the inner end portion 40c of the first conductor pattern 43A in the thickness direction of the substrate 30 and is connected to the through-hole conductor 48.

The through-hole conductor 48 (penetration portion) is provided to penetrate an edge region of the through hole 32 of the substrate 30, and connects the end portion 40c of the first conductor pattern 43A and the end portion 40d of the second conductor pattern 43B. The through-hole conductor 48 may be constituted by a hole provided in the substrate 30 and a conductive material (for example, a metal material such as Cu) filled in the hole. The through-hole conductor 48 has, for example, a columnar (cylindrical, prismatic, or the like) outer shape extending in the thickness direction of the substrate 30.

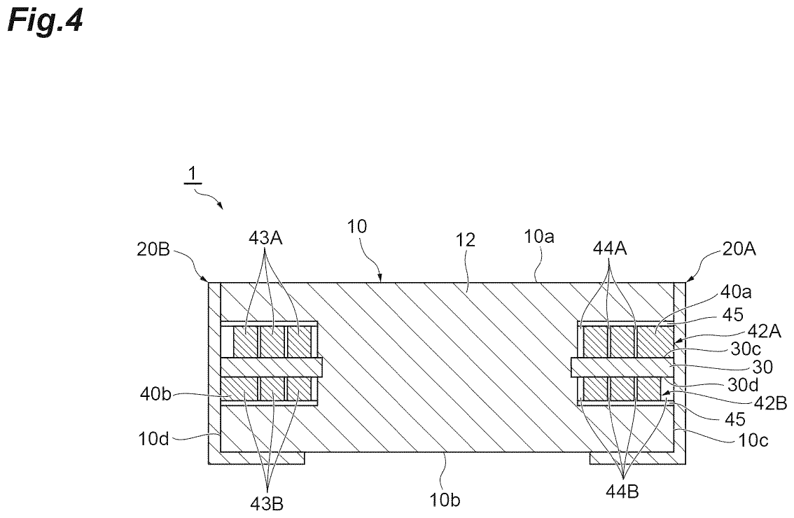

As shown in FIG. 4, the first coil portion 42A and the second coil portion 42B have resin walls 44A and 44B, respectively. The resin wall 44A of the first coil portion 42A is located between the lines of the first conductor pattern 43A, on the inner periphery of the first conductor pattern 43A, and on the outer periphery of the first conductor pattern 43A. Similarly, the resin wall 44B of the second coil portion 43B is located between the lines of the second conductor pattern 43B, on the inner periphery of the second conductor pattern 43B, and on the outer periphery of the second conductor pattern 43B. In the present embodiment, the resin walls 43A and 43B located on the inner periphery and the outer periphery of the conductor patterns 44A and 44B are designed to be thicker than the resin walls 43A and 43B located between the lines of the conductor patterns 44A and 44B.

The resin walls 44A and 44B are made of an insulating resin material. The resin walls 44A and 44B can be provided on the substrate 30 before the first conductor pattern 43A and the second conductor pattern 43B are formed. In this case, the first conductor pattern 43A and the second conductor pattern 43B are formed by plating and growth at the inter-walls defined by the resin walls 44A and 44B. The resin walls 44A and 44B can be provided on the substrate 30 after the first conductor pattern 43A and the second conductor pattern 43B are formed. In this case, the resin walls 44A and 44B are provided by filling, coating, or the like in the first conductor pattern 43A and the second conductor pattern 43B.

Each of the first coil portion 42A and the second coil portion 42B is provided with an insulating layer 45 that integrally covers from the upper surface side the first conductor pattern 43A and the second conductor pattern 43B, and the resin wall 44A and 44B. The insulating layer 45 may be made of an insulating resin or an insulating magnetic material.

The magnetic body 12 integrally covers the substrate 30 and the coil conductor 40. More specifically, the magnetic body 12 covers the substrate 30 and the coil conductor 40 from above and below and also covers the outer periphery of the substrate 30 and the coil conductor 40. The magnetic body 12 fills the inside of the through hole 32 of the substrate 30 and the inner region of the coil conductor 40. The magnetic body 12 forms all surfaces (that is, the main surfaces 10a and 10b, the end surfaces 10c and 10d, and the side surfaces 10e and 10f) of the element body 10.

The magnetic body 12 is composed of a metal magnetic powder-containing resin. The magnetic metal powder-containing resin is a bound powder in which magnetic metal powder is bound by a binder resin. The metal magnetic powder of the metal magnetic powder-containing resin constituting the magnetic body 12 is configured to contain magnetic powder containing at least Fe (for example, iron-nickel alloy (permalloy), carbonyl iron, amorphous, amorphous or crystalline FeSiCr based alloy, or sendust). The binder resin is, for example, a thermosetting epoxy resin. In the present embodiment, the content of the metallic magnetic powder in the bound powder is 80 to 92 vol % in terms of volume percent, and 95 to 99 wt % in terms of weight percent. From the viewpoint of magnetic characteristics, the content of the metallic magnetic powder in the bound powder may be 85 to 92 vol % in terms of volume percent and 97 to 99 wt % in terms of weight percent. The magnetic powder of the metal magnetic powder-containing resin constituting the magnetic body 12 may be a powder having one type of average particle diameter or may be a mixed powder having a plurality of types of average particle diameters. In the case where the metal magnetic powder of the metal magnetic powder-containing resin constituting the magnetic body 12 is a mixed powder, the types of magnetic powder having different average particle diameters and the Fe composition ratio may be the same or different.

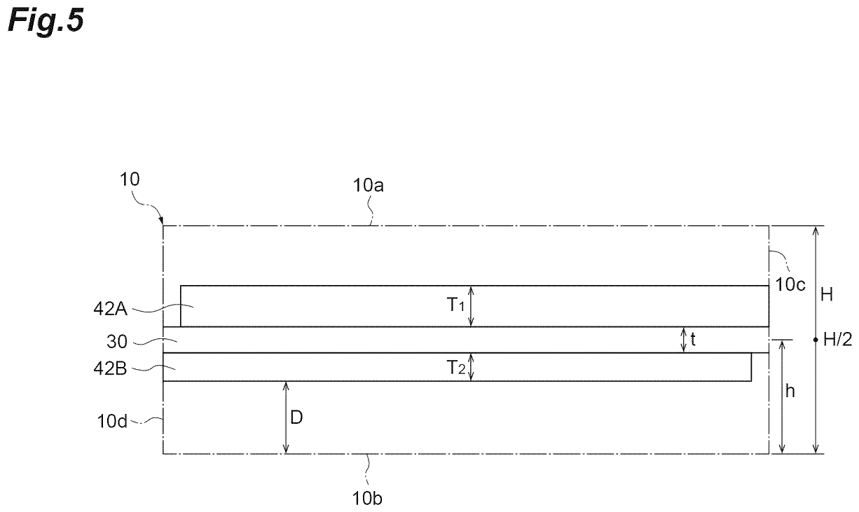

Next, the positional relationship and thicknesses of the substrate 30, the first coil portion 42A, and the second coil portion 42B will be described with reference to the side view of FIG. 5.

The substrate 30 extends so as to be orthogonal to the facing direction of the main surfaces 10a and 10b of the element body 10. In the present embodiment, the substrate 30 extends at the height position h same as an intermediate height position (H/2) of the element body 10 (h=H/2), where H is the length of the element body 10 in the facing direction of the main surfaces 10a and 10b of the element body 10 (i.e., height). The substrate 30 has uniform lengths (i.e., thicknesses) in the facing direction of the main surfaces 10a and 10b, and has a uniform thickness t. The thickness t of the substrate 30 is, for example, 50 μm. The height H of the element body 10 is 500 μm, for example.

The first coil portion 42A provided on the upper surface 30c of the substrate 30 also has uniform lengths (i.e., thicknesses) in the facing direction of the main surfaces 10a and 10b, and has a uniform thickness T₁. The thickness T₁ is, for example, 115 μm. In the first coil portion 42A, the first conductor pattern 43A and the resin wall 44A have uniform thicknesses T₁, and an upper end surface of the first conductor pattern 43A and an upper surface end of the resin wall 44A form a flat surface (that is, are flush with each other).

The second coil portion 42B provided on the lower surface 30d of the substrate 30 also has uniform lengths (i.e., thicknesses) in the facing direction of the main surfaces 10a and 10b, and has a uniform thickness T₂. The thickness T₂ is different from the thickness T₁ and is designed to be smaller than the thickness T₁ in the present embodiment (T₂<T₁). The thickness T₂ is, for example, 85 μm. In the second coil portion 42B, the second conductor pattern 43B and the resin wall 44B have uniform thicknesses T₂, and a lower end surface of the second conductor pattern 43B and a lower end surface of the resin wall 44B form a flat surface (that is, are flush with each other).

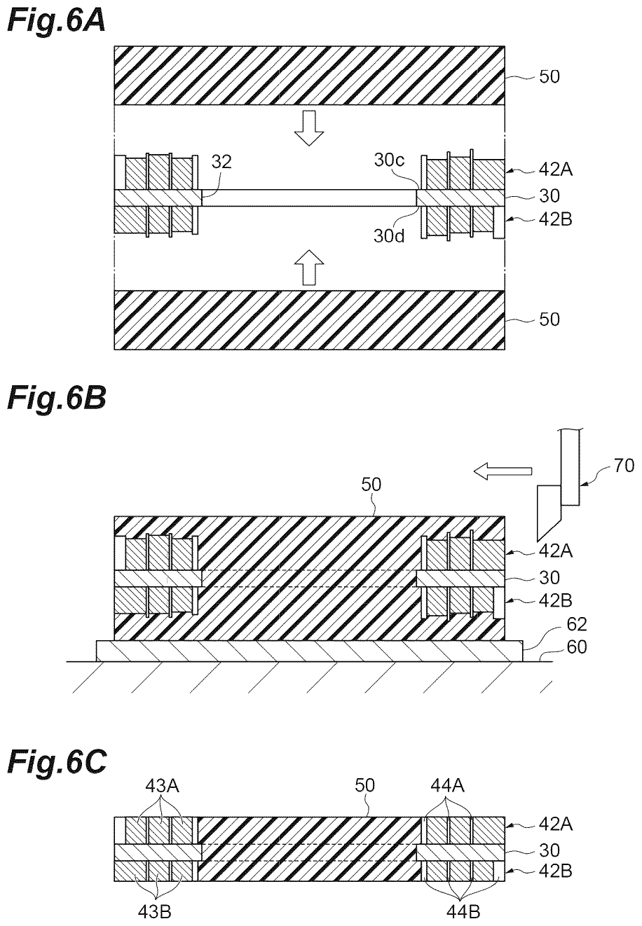

The first coil portion 42A and the second coil portion 42B can be formed by the steps shown in FIGS. 6A to 6C.

As shown in FIG. 6A, in a state in which the first coil portion 42A and the second coil portion 42B are provided on both surfaces 30c and 30d of the substrate 30, the heights of the conductor patterns 43A and 43B and the resin-wall 44A and 44B may not be uniform, and unevenness may occur. A pair of resist films 50 (peel-off type dry film resist (DFR)) are attached to the substrate 30 provided with the first coil portion 42A and the second coil portion 42B in which the heights of the first conductor pattern 44A and the second conductor patterns 44B are not uniform as described above, from both of the main surfaces 30c and 30d sides. As a result, the first coil portion 42A and the second coil portion 42B are sandwiched between the pair of resist films 50 together with the substrate 30 and are embedded in the resist films 50 as shown in FIG. 6B.

Next, polishing using a polishing machine is performed. Specifically, the substrate 30 embedded in the resist film 50, the first coil portion 42A, and the second coil portion 42B are placed on the chucking table 60 of the polishing machine via an adhesive tape 62 (for example, a UV tape) in a posture in which the substrate 30 is parallel to the chucking table 60. Then, the first coil portion 42A and the second coil portion 42B are exposed from the resist film 50 by cutter polishing using a cutter unit 70 (for example, a diamond cutter unit). The polishing is performed on each of the upper surface 30c side and the lower surface 30d side of the substrate 30.

As a result, as shown in FIG. 6C, the first conductor pattern 43A and the resin wall 44A of the first coil portion 42A on the upper surface 30c of the substrate 30 are flush with each other, and similarly, the second conductor pattern 43B and the resin wall 44B of the second coil portion 42B on the lower surface 30d of the substrate 30 are flush with each other. In polishing, the thicknesses of the first coil portion 42A and the second coil portion 42B after polishing can be adjusted respectively by adjusting the relative height position between the substrate 30 and the cutter unit 70. In the present embodiment, the thicknesses are adjusted such that the thickness T₂ of the second coil portions 42B are smaller than the thickness T₁ of the first coil portions 42A.

After polishing, the resist film 50 is removed, the insulating layer 45 is provided on the first coil portion 42A and the second coil portion 42B, and the first coil portion 42A and the second coil portion 42B are integrally covered with the magnetic body 12, thereby obtaining the above-described element body 10.

The inventors have confirmed the influence of the relationship between the thicknesses T₁ and T₂ of the first coil portion 42A and the second coil portion 42B on the characteristics of the coil by the following experiment.

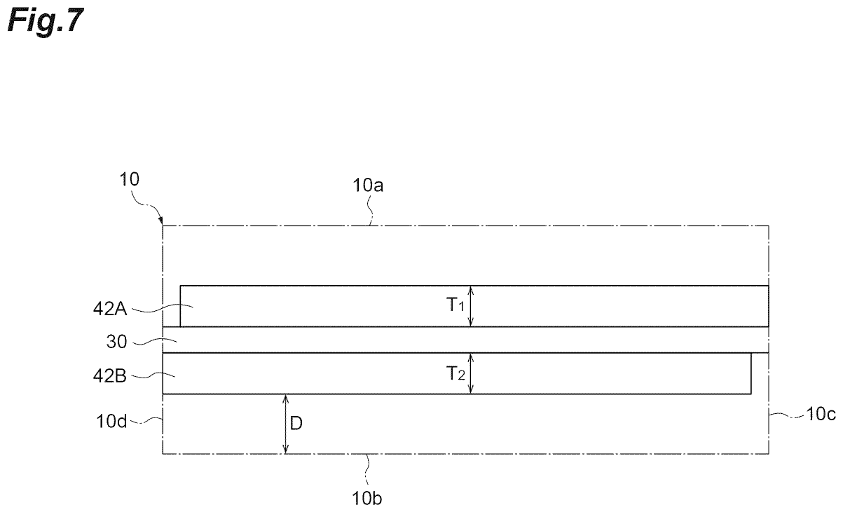

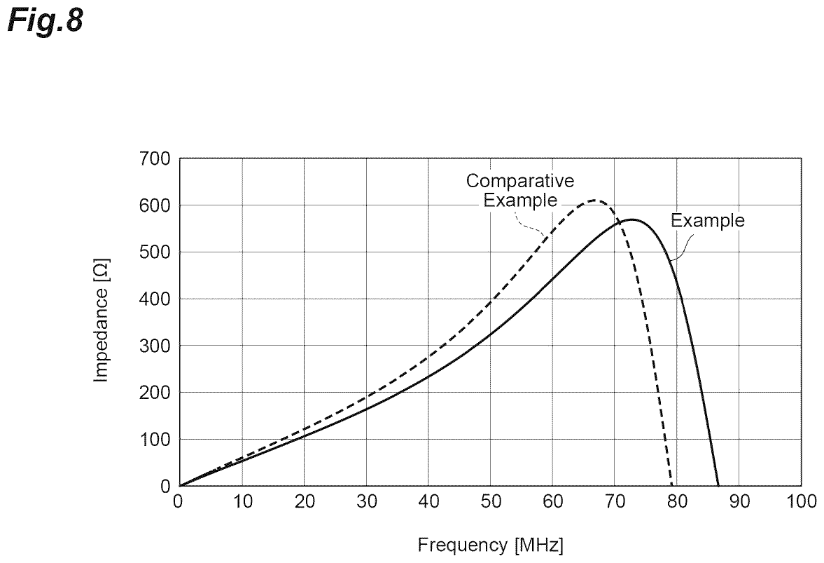

In the experiment, a sample (Example) in which the thickness T₂ of the second coil portion 42B was smaller than the thickness T₁ of the first coil portion 42A as shown in FIG. 5 and a sample (Comparative Example) in which the thickness T₂ of the second coil portion 42B and the thickness T₁ of the second coil portion 42A was the same as shown in FIG. 7 were prepared, and impedance values at respective frequencies were obtained. FIG. 8 is a graph showing the results.

From the graph of FIG. 8, it can be confirmed that the peak of the sample of Example is shifted to the high frequency side compared to the sample of Comparative Example, and the self-resonance frequency (SRF) is improved to the high frequency side. It is considered that this is because the distance D from the second coil portion 42B to the mounting surface 10d of the element body 10 is increased as a result of the thickness T₂ of the second coil portion being reduced, and the stray capacitance between the portions of the terminal electrodes located on the mounting surface (i.e., the portions 20b of the external terminal electrode 20A and 20B shown in FIG. 2) and the second conductor pattern of the second coil portion is reduced.

As a result, by making the thickness T₂ of the second coil portions 42B smaller than the thickness T₁ of the first coil portions 42A, it is possible to improve self-resonance frequencies, which are a type of coil characteristics.

When the coil component 1 is used, a predetermined voltage is applied between the pair of external terminal electrodes 20A and 20B. For example, when the coil component 1 is used in a circuit of a power supply system, a relatively high voltage is applied, and the coil conductor 40 may become a heating element that generates high heat. In this case, the coil component 1 is required to have a heat dissipation characteristic with respect to heat of the coil conductor 40 generated in the element body 10 as one of coil characteristics.

In the first conductor pattern 43A and the second conductor pattern 43B, it is considered that the smaller the thickness is, the smaller the cross-sectional dimension is, and the heat is more easily generated. In this case, since the mounting surface 10b side of the element body 10 may have a higher temperature than the main surface 10a side thereof, it is preferable to promote heat dissipation from the mounting surface 10b. In the coil component 1, since the coil component 1 is mounted on the mounting substrate such that the mounting substrate on which the coil component 1 is mounted and the mounting surface 10b of the element body 10 face each other, heat generated in the element body 10 is easily transmitted from the mounting surface 10b to the mounting substrate, and heat dissipation in the mounting surface 10b of the element body 10 is improved.

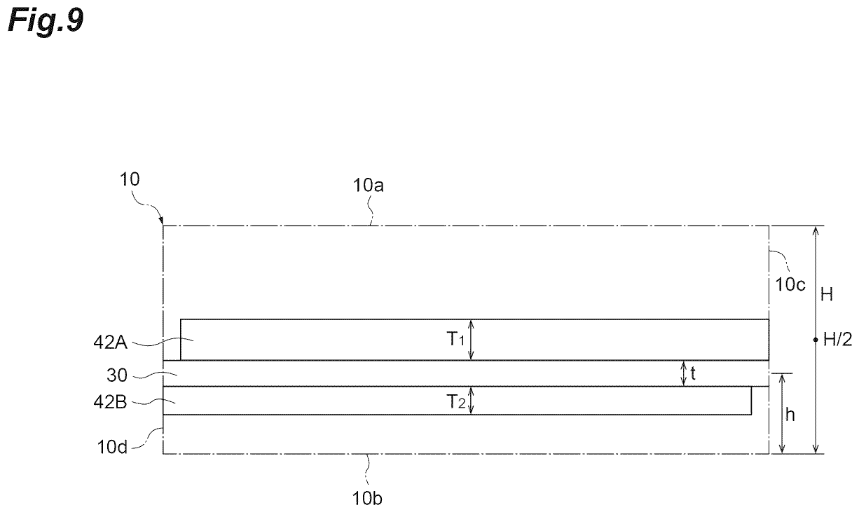

In order to further improve heat dissipation in the mounting surface 10b of the element body 10, as shown in FIG. 9, the substrate 30 can be brought close to the mounting surface 10b side. In the embodiment shown in FIG. 9, the substrate 30 extends at a height position h lower than an intermediate height position (H/2) of the element body 10 in the thickness direction (h<H/2). In this case, since the substrate 30 is closer to the mounting surface 10b side than in the embodiment shown in FIG. 5 (that is, h=H/2), heat generated in the element body 10 is more easily transmitted from the mounting surface 10b to the mounting substrate, and heat dissipation in the mounting surface 10b of the element body 10 is further improved.

On the other hand, in the case that the thickness T₁ of the first coil portion 42A is smaller than the thickness T₂ of the second coil portion 42B (T₁<T₂), the temperature on the main surface 10a side is higher than the temperature on the mounting surface 10b side. Therefore, it is preferable to promote heat dissipation from the main surface 10a. In order to improve heat dissipation in the main surface 10a of the element body 10, the substrate 30 may be brought close to the main surface 10a side.

As described above, in the coil component 1, the thicknesses T₁ and T₂ of the first coil portion 42A and the second coil portion 42B are different from each other (T₁+T₂), and thus the characteristics such as the self-resonance frequencies and the heat dissipation properties are improved.

The coil component described above is not limited to the form described above, and various forms can be adopted.

For example, the planar shape of the conductor pattern constituting the coil conductor is not limited to an elliptical shape, and may be, for example, a perfect circular shape or a polygonal shape. The shape of the external terminal electrode is not limited to a shape that continuously covers two surfaces of the end surface and the mounting surface, and may be a shape that covers only the end surface, or may be a shape that continuously covers five surfaces of the end surface, both main surfaces on the end surface side, and both side surfaces on the end surface side.

What is claimed is:

1. A coil component comprising:
an element body;
a substrate disposed inside the element body;
a coil conductor including a first winding portion provided in a planar spiral shape on one surface of the substrate, a second winding portion provided in a planar spiral shape on the other surface of the substrate, and a penetration portion penetrating the substrate and connecting end portions of the first winding portion and the second winding portion to each other; and
a pair of terminal electrodes provided on a surface of the element body and connected to the first winding portion and the second winding portion of the coil conductor, respectively,
wherein when a thickness of the first winding portion in a thickness direction of the substrate is a first thickness and a thickness of the second winding portion is defined as a second thickness, the first thickness and the second thickness are different from each other.

2. The coil component according to claim 1, wherein in the thickness direction of the substrate, the substrate extends at a height position shifted from an intermediate height position of the element body.

3. The coil component according to claim 1, wherein in the thickness direction of the substrate, the substrate extends at an intermediate height position of the element body.

4. The coil component according to claim 1, wherein the element body has a pair of end surfaces orthogonal to the substrate and facing each other and a mounting surface orthogonal to the thickness direction of the substrate on the other surface side of the substrate, and
wherein the pair of terminal electrodes is provided on each of the pair of end surfaces.

5. The coil component according to claim 4, wherein each of the terminal electrodes has an L shape, the each of the terminal electrodes continuously covering the end surface and the mounting surface.

6. The coil component of claim 4, wherein the second thickness is smaller than the first thickness.

7. The coil component according to claim 1, wherein the element body is made of a material containing metal powder and resin.
